(19) United States
(12) Patent Application Publication
(10) Pub. No.: US 2016/0093182 A1
(43) Pub. Date: Mar. 31, 2016

(54) STORE INTELLIGENCE SENSOR PLATFORM FOR IMPROVING CUSTOMER EXPERIENCE AND DATA ANALYTICS

(71) Applicants: Charles T. Turgeon, Lighthouse Point, FL (US); Craig R. Szklany, Lighthouse Point, FL (US)

(72) Inventors: Charles T. Turgeon, Lighthouse Point, FL (US); Craig R. Szklany, Lighthouse Point, FL (US)

(73) Assignee: Tyco Fire & Security GmbH, Neuhausen Am Rheinfall (CH)

(21) Appl. No.: 14/501,092

(22) Filed: Sep. 30, 2014

(51) Int. Cl. G08B 13/24

(52) U.S. Cl. CPC G08B 13/2402

(57) ABSTRACT

Systems (100) and methods (400) for providing store intelligence. The methods involve: generating sensor data relating to movement of a security tag (122) by at least one sensor of a plurality of sensors (126) disposed in the security tag; analyzing, by an electronic device (140) remotely located from the security tag, the sensor data to determine if the security tag is currently being moved in an abnormal manner; and selectively performing, by the electronic device, first operations facilitating facility security if a determination is made that the security tag is currently being moved in an abnormal manner.

### FIELD OF THE INVENTION

This document relates generally to store intelligence systems for retail applications. More particularly, this document relates to store intelligence sensor platforms for improving customer experience, store security and data analytics.

### BACKGROUND OF THE INVENTION

Electronic Article Surveillance (“EAS”) systems are well known in the art. EAS systems employ security tags to protect retail items from theft. Conventional security tags are passive, and therefore are capable of only a limited one way transfer of information. Some security tags have a self-alarming feature. In this case, an alarm of the security tag is issued in response to a defeat thereof or upon movement of the security tag into a detection field of an EAS system.

Indoor proximity systems are well known in the art. One conventional indoor proximity system is known as iBeacon®. iBeacon® employs Bluetooth communication technology to connect to mobile communication devices (e.g., cellular phones). Upon establishment of such connection, the iBeacon® requests and receives first information from each mobile communication device. The first information includes information which has been agreed upon by the cell user for provision to the iBeacon®. The iBeacon® can also push second information to the mobile communication device. The second information can include, but is not limited to, coupon related information which has been selected based on the store a customer is presently in or entering into. The Bluetooth technology is based on a 2.45 GHz transmission, and its data rate ranges from 1 Mbit to 24 Mbit.

### SUMMARY OF THE INVENTION

The present invention concerns implementing systems and methods for providing facility intelligence. The methods comprise generating sensor data relating to movement of a security tag by at least one sensor of a plurality of sensors disposed in the security tag. The sensor data may further relate to changes in light conditions of a surrounding environment, changes in a temperature of the surrounding environment, changes in an amount of fluid in a surrounding environment, or changes in a magnetic field strength generated by the security tag.

The sensor data is then analyzed by an electronic device remotely located from the security tag. This analysis is performed to determine if the security tag is currently being moved. If so, a determination may also be made as to whether or not the security tag's movement is normal or abnormal. If a determination is made that the security tag is currently being moved in an abnormal manner, then the electronic device performs first operations that facilitate facility security. For example, the security tag's alarm is issued, an image is captured of a person in possession of the security tag, store personnel is notified of the security tag's abnormal movement, or the store personnel is dispatched to a location within a facility at which the security tag resides.

In contrast, if a determination is made that the security tag is not being moved in an abnormal manner, then the electronic device selectively performs second operations facilitating customer service. For example, select pre-stored article-related information and/or promotional materials are provided to a mobile communication device of a person in possession of the security tag. The pre-stored article-related information and/or promotional materials can additionally or alternatively be sent from the security tag to the mobile communication device automatically upon detection of movement of the security tag or in response to a query received from the mobile communication device.

Alternatively or additionally, the sensor data is analyzed to determine: if the security tag is being concealed, shielded or placed in a metal lined bag; if the security tag is located in or traveling towards a high risk location of a facility; and/or if an attempt is being made to defeat the security tag. If a determination is made that the security tag is being concealed, shielded or placed in a metal lined bag, then the electronic device performs third operations facilitating facility security. The third operations comprise issuing an alarm of the security tag and/or notifying store personnel of the security tag's concealment, shielding or detuning. If a determination is made that the security tag is located in or traveling towards a high risk location of a facility, then the electronic device selectively performs fourth operations facilitating facility security. If a determination is made that an attempt is being made to defeat the security tag, then electronic device selectively performs fifth operations facilitating facility security.

### DESCRIPTION OF THE DRAWINGS

Embodiments will be described with reference to the following drawing figures, in which like numerals represent like items throughout the figures, and in which:

FIG. 1 is a perspective view of an exemplary system that is useful for understanding the present invention.

FIG. 2 is a block diagram of an exemplary architecture for a beacon shown in FIG. 1.

FIG. 3 is a block diagram of an exemplary architecture for a mobile communication device shown in FIG. 1.

FIGS. 4A-4B collectively provide a flow diagram of an exemplary method for providing store intelligence.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present invention provides a novel intelligence system for various applications, such as retail applications. The intelligence system employs a Short Range Communication (“SRC”) network (e.g., an iBeacon® based network) and security tags with a plurality of different types of sensors disposed therein. The sensors can include, but are not limited to, proximity sensors, temperature sensors, accelerometers, liquid sensors, light sensors, magnetic field sensors, and/or location sensors. These sensors are used to facilitate improved store analytics, improved customer service and/or enhanced store security. Accordingly, the sensors support two way communications with external devices, such as beacons and Mobile Communication Devices (“MCDs”). More specifically, the sensors are configured to transmit information to the external devices via SRCs (e.g., Bluetooth technology) and receive information from the external devices via SRCs.

In this present invention, sensor outputs are aggregated in order to determine if a security tag has found its way into a circumstance that is predictive in nature. For example, the sensor outputs are used to detect: when the security tag is being handled by an interested customer such that article-related information and/or promotional materials can be provided to the customer; when the security tag is being handled by a possible thief thereby indicating that an article might be stolen in the near future; and/or when the security tag is being tampered with thereby indicating that the security tag might be defeated in the near future. The manner in which such detections are made will become evident as the discussion progresses.

Upon one or more of the above-listed detections certain measures may be taken. For example, if it is determined that a retail item is in the possession of an interested customer, then the security tag and/or a remote device can provide pre-stored product-related information to the customer's MCD. Additionally or alternatively, store personnel can be dispatched to provide the customer with an improved customer service experience. In contrast, if it is determined that the retail item is in the possession of a possible thief, then the security tag's alarm can be issued and/or the requisite store personnel can be informed and/or dispatched to intercept the thief. Notably, the present invention provides a novel predictive and preventative type of loss prevention technique for business organizations selling, renting, or loaning items to the general public (e.g., retail stores or libraries).

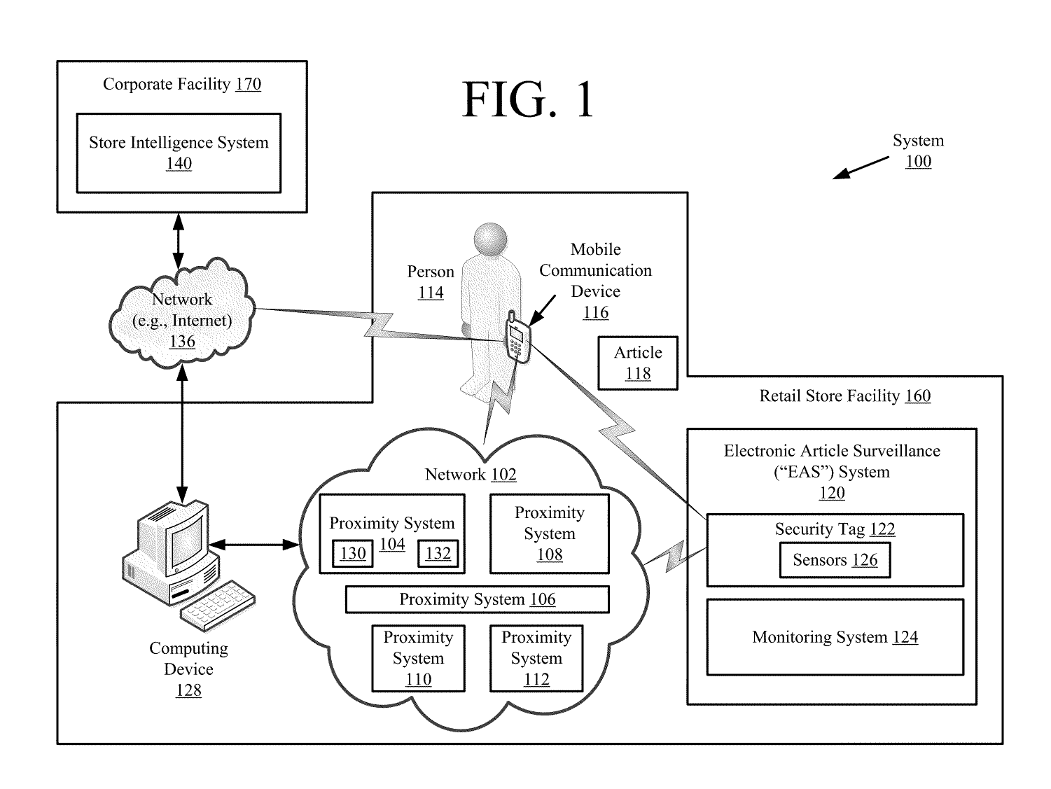

Referring now to FIG. 1, there is provided a schematic illustration of an exemplary system 100 that is useful for understanding the present invention. The system 100 is generally configured to allow improved retail store intelligence and customer service using wireless communication technology. The wireless communication technology can include, but is not limited to, SRC technology and/or mobile communication technology. The SRC technology includes, but is not limited to, Bluetooth technology. The mobile communication technology can include, but is not limited to, Radio Frequency (“RF”) communication technology.

As shown in FIG. 1, system 100 comprises a Retail Store Facility (“RSF”) 160 and a Corporate Facility (“CF”) 170 which are communicatively coupled to each other via a network (e.g., the Internet) 136. Although FIG. 1 is shown as having two facilities, the present invention is not limited in this regard. For example, the facilities 160, 170 can reside in the same or different building or geographic area. Alternatively or additionally, the facilities 160, 170 can be the same or different sub-parts of a larger facility.

The RSF 160 is generally configured to provide enhanced store security, store intelligence and customer service. In this regard, the RSF 160 comprises a network 102 defined by a plurality of proximity systems 104-112 disposed at various strategic locations therein. For example, a first proximity system 104 is coupled to checkout equipment. A second proximity system 106 is disposed on or in an EAS system 120. In this case, the second proximity system 106 may be disposed on at least one pedestal located at an exit/entry point of the RSF 160. A third proximity system 108 is disposed in a fitting room. Each of the remaining proximity systems 110, 112 is disposed in another high risk location within the RSF 160 (e.g., a bathroom).

Each proximity system 104-112 comprises a beacon 130 and/or a camera 132. The beacon 130 is generally operative to communicate information to and/or from other communication devices via SRC technology (e.g., Bluetooth technology). The other communication devices can include, but are not limited to, security tags 122 coupled to articles 118 (e.g., merchandise), a computing device 128 of the RSF 160 and/or an MCD 116 of a person 114 located within the RSF 160. The computing device 128 may act as a relay device for transferring information between the proximity systems 104-112 of the RSF 160 and a Store Intelligence System (“SIS”) 140 of the CF 170.

In some scenarios, the beacon 130 comprises an iBeacon®. iBeacons® are well known in the art, and therefore will not be described in detail herein. Still, it should be understood that the iBeacon® can be used as a transmit device or as a receive device using Bluetooth technology. The camera 132 is used to obtain time stamped images of people entering, present within, and/or exiting the RSF 160. The present invention is not limited to cameras as devices for obtaining information relating to characteristics (e.g., facial images) of people. Any other biometric device could also be employed which facilitate identification of a person.

The information communicated from the beacon 130 to the SIS 140 can include, but is not limited to, a unique identifier of the beacon 130, a unique identifier of the MCD 116, and/or tag-related information (e.g., a unique identifier for the security tag and/or sensor data), and/or. The unique identifier of the beacon 130 provides a means to determine the location of a person 114 and/or a security tag 122 within the RSF 160. The unique identifier of the MCD 116 provided a means to determine the identity of the person 114. The tag-related information can be used to track movement of the security tag 122 within the RSF 160, track the number of customers interested in and/or actually purchased a retail item, determine if customer service actions should be performed in relation to a particular customer, determine whether article-related and/or promotional information should be provided to a particular customer, determine if the security tag should be deactivated and/or detached from an article 118, determine if security measures need to be performed in relation to a particular customer, and inform store personnel of the results of various analytic based operations. The store personnel can be informed in real time or at user-specified times via a communication device (e.g., a mobile phone or handheld equipment).

For example, let's assume that the person 114 is in possession of the article 118 having the security tag 122 attached thereto. Sensors 126 of the security tag 122 obtain sensor data relating to the movement of the security tag, changes in light conditions of an environment surrounding the security tag, changes in the temperature of the surrounding environment, changes in an amount of fluid/liquid of the surrounding environment, and/or changes in a magnetic field generated by the security tag. The sensor data is then sent to the SIS 140 via communication components 102, 128, 136. At the SIS 140, the sensor data is used for analytic based operations. The analytic based operations are performed in accordance with pre-defined user profiles, user preferences and/or business rules stored in the SIS 140. The user profiles, user preferences and business rules are customizable.

The analytic based operations involve performing at least one of the following operations: determining when a security tag is being moved; track movement of the security tag; determine if the movement is normal movement indicating that an article is in the possession of an interested customer or abnormal movement indicating that the article is in the possession of a possible thief; track the location of the security tag in the RSF; determine if the security tag is currently in a high risk location within the RSF (e.g., exit or fitting room); cause an image to be captured of the person in possession of the security tag; and/or provide the requisite store personnel with an indication of the security tag's movement, the type of the security tag's movement, the current location of the security tag in the RSF and/or the recently captured image of the person in possession of the security tag.

Abnormal movement can be detected based on a current orientation of a security tag, a velocity and direction of a security tag's movement (e.g., a relatively fast downward movement of the security tag may indicate a defeat attempt such as slamming the security tag on a hard surface), a pattern of the security tag's movement over a given period of time (e.g., rapid changes in the altitude of the article may indicate that the article is being held by a person running or walking relatively fast), and/or relative altitudes of different portions of the security tag (e.g., an altitude difference of the two ends of a security tag relative to a center portion of the security tag may indicate that a defeat attempt has occurred such as bending the security tag to deform the same). Pre-stored threshold values and/or sensor data patterns (e.g., accelerometer data patterns) can be employed in comparison operations to distinguish between normal movements and abnormal movements.

Additionally or alternatively, the analytic based operations can be performed to: determine if the security tag is being concealed, shielded or placed in a metal lined bag (e.g., a booster bag); cause issuance of the security tag's alarm; and/or notify store personal of the results of the analytic based operations prior to removal of the article from the RSF 160. The determination can be made based on sensor data from a light sensor indicating changes in ambient light in a surrounding environment over a given period of time and/or sensor data indicating that the security tag has been detuned.

The analytic based operations may also be performed to: detect changes in an amount of fluid/liquid surrounding the security tag; detect changes in an ambient temperature of a surrounding environment over a given period of time; cause issuance of the security tag's alarm; and/or notify store personal of the results of the analytic based operations prior to removal of the article from the RSF 160. Changes in an amount of fluid/liquid contained in a surrounding environment may indicate an occurrence of a defeat attempt by the submission of all or a portion of a security tag in a fluid/liquid. Changes in an ambient temperature may indicate an occurrence of a defeat attempt by melting a security tag using a lighter or other heating apparatus.

Notably, in other scenarios, the sensor data may be additionally or alternatively communicated to the SIS 140 via MCDs 116 of customers. In this case, the MCD 116 has an SRC application installed thereon. When the person 114 moves into proximity of a beacon 130, the beacon communicates its unique identifier to the MCD 114 via an SRC communication. Also, the camera 132 captures at least one time stamped image of the person 114, and forwards the captured image to the SIS 140 of the CF 170 directly (not shown in FIG. 1) or indirectly via a computing device 128. The MCD 116 sends the unique identifier of the beacon 130, its own unique identifier (e.g., MAC address) and/or sensor data received from a security tag 122 to the SIS 140 via network 136.

The SRC application installed on the MCD 116 may also be operative to query a security tag for article-related information. In response to such a query, the security tag communicates pre-stored article-related information to the MCD 116. An indicator may also be sent to the SIS indicating that such a query was made by MCD 116. The indicator can be sent from (1) the security tag 122 to the SIS 140 via MCD 116 and/or a proximity system 104-112, and/or (2) the MCD 116 to the SIS 140 via network 136. In effect, the SIS 140 can track how many customers and which customers had some interest in a given product. The SIS 140 can also optionally selectively provide additional article-related information and/or promotional materials to the customer associated with the MCD 116.

Although the SIS 140 is shown in FIG. 1 as residing in the CF 170, the SIS 140 does not need to be remote from the RSF 160 in all situations. For example, if the RSF is part of a relatively small store chain, then the SIS might be located in one of the retail stores. The SIS could also be a cloud function as well. In this case, the SIS might not be located in the CF 170, but rather in a server rented from a cloud provider.

In view of the forgoing, various operations are performed at the SIS 140 using the two unique identifiers, the time stamped image and/or sensor data. For example, the two unique identifiers, time stamped image and/or sensor data are used to (1) increase the security and safety of the RSF 160, (2) selectively provide product-related and/or promotional materials to the person, (3) track security tags paths of travel through the retail store, (5) generate a map indicating where one or more security tags are located within the RSF 160, (6) improve the shopping and/or check-out experience of a customer, (7) collect and analyze statistical information regarding shopping interests and habits of customers, and/or (8) collect and analyze information regarding behavioral patterns of thieves. With regard to (7), the security tag 122 and/or SIS 140 is(are) operative to sense and/or receive customer interaction or queries for item details and social “likes” via MCD 116.

As noted above, the RSF 160 comprises an EAS system 120. The EAS system 120 includes a monitoring system 124 and at least one security tag 122. Although not shown in FIG. 1, the security tag 122 is attached to an article 118 for protecting the article 118 from an unauthorized removal from the RSF 160. The monitoring system 124 establishes a surveillance zone (not shown) within which the presence of the security tag 122 can be detected. The surveillance zone is established at an access point (not shown) for the RSF 160. If the security tag 122 is carried into the surveillance zone, then an alarm is triggered to indicate a possible unauthorized removal of the article 118 from the RSF 160.

During store hours, a customer may desire to purchase the article 118. The customer can purchase the article 118 via a fixed POS station (e.g., a checkout counter) or a mobile POS station (e.g., MCD 116). Once the article 118 has been successfully purchased, the SIS 140 performs operations to cause the disablement and/or detachment of the security tag 122 from the article 118. In effect, an alarm is not issued when the customer passes through the interrogation zone.

In some cases, a person may attempt to steal the article 118, and thus leave the RSF 160 with the article 118 having an activated security tag 122 coupled thereto or a maliciously deactivated secure tag 122 coupled thereto. When the person walks through the interrogation zone of the EAS system 120, an alarm may issue as discussed above. However, the person may not be stopped if a number of other people (e.g., 5) pass through the interrogation zone at the same or substantially the same time. Still, each time a person passes through the interrogation zone a beacon 130 of a proximity system causes its unique identifier and a unique identifier of the MCD carried by the person to be communicated to the SIS 140. Additionally, the camera of the proximity system is triggered to capture a time stamped image of the person and forward the same to the SIS 140 for storage and facial recognition analysis. As such, a database of MCD unique identifiers and time stamped images is obtained that is useful for identifying thieves.

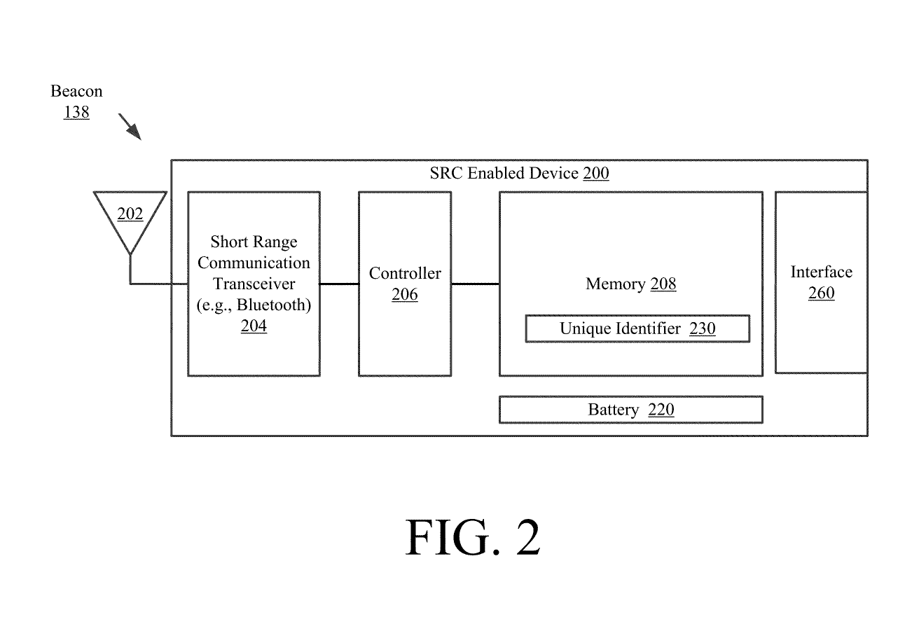

Referring now to FIG. 2, there is provided a schematic illustration of an exemplary architecture for beacon 130 of FIG. 1. Beacon 130 can include more or less components than that shown in FIG. 2. However, the components shown are sufficient to disclose an illustrative embodiment implementing the present invention. Some or all of the components of the beacon 130 can be implemented in hardware, software and/or a combination of hardware and software. The hardware includes, but is not limited to, one or more electronic circuits. The electronic circuit may comprise passive components (e.g., capacitors and resistors) and active components (e.g., processors) arranged and/or programmed to implement the methods disclosed herein.

The hardware architecture of FIG. 2 represents an embodiment of a representative beacon 130 configured to facilitate improved store intelligence, store security, data analytics and customer service. In this regard, the beacon 130 comprises an SRC enabled device 200 for allowing data to be exchanged with an external device (e.g., MCD 116 and/or security tag 122 of FIG. 1) via SRC technology (e.g., Bluetooth technology). The components 204-208, 260 and a battery 220 shown in FIG. 2 may be collectively referred to herein as the SRC enabled device 200.

The SRC enabled device 200 comprises an antenna 202 for allowing data to be exchanged with the external device via SRC technology. The antenna 202 is configured to receive SRC signals from the external device and/or transmit SRC signals generated by the SRC enabled device 200. The SRC enabled device 200 comprises an SRC transceiver 204. SRC transceivers are well known in the art, and therefore will not be described herein. However, it should be understood that the SRC transceiver 204 transmits SRC signals including first information to the external device, and processes received SRC signals to extract second information therefrom. The first information includes a unique identifier 230 of the beacon 130. The unique identifier 230 provides a means for an SIS to determine the location of a person or security tag located within a given facility (e.g., RSF 160 of FIG. 1). The second information can include, but is not limited to, a unique identifier of an external device (e.g., MCD 116 and/or security tag 122 of FIG. 1) and/or sensor data received from an external device (e.g., security tag 122 of FIG. 1). The SRC transceiver 204 may pass the extracted second information to the controller 206 via interface 260.

At the controller 206, the information may be pre-processed to determine how the SRC signal is to be handled by the beacon 130. For example, the unique identifier of the external device and the unique identifier of the beacon may be forwarded to an SIS for various purposes, such as security purposes, client service purposes and/or promotional purposes.

Notably, the memory 208 may be a volatile memory and/or a non-volatile memory. For example, the memory 208 can include, but is not limited to, a Random Access Memory (“RAM”), a Dynamic Random Access Memory (“DRAM”), a Static Random Access Memory (“SRAM”), a Read-Only Memory (“ROM”) and a flash memory. The memory 208 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure.

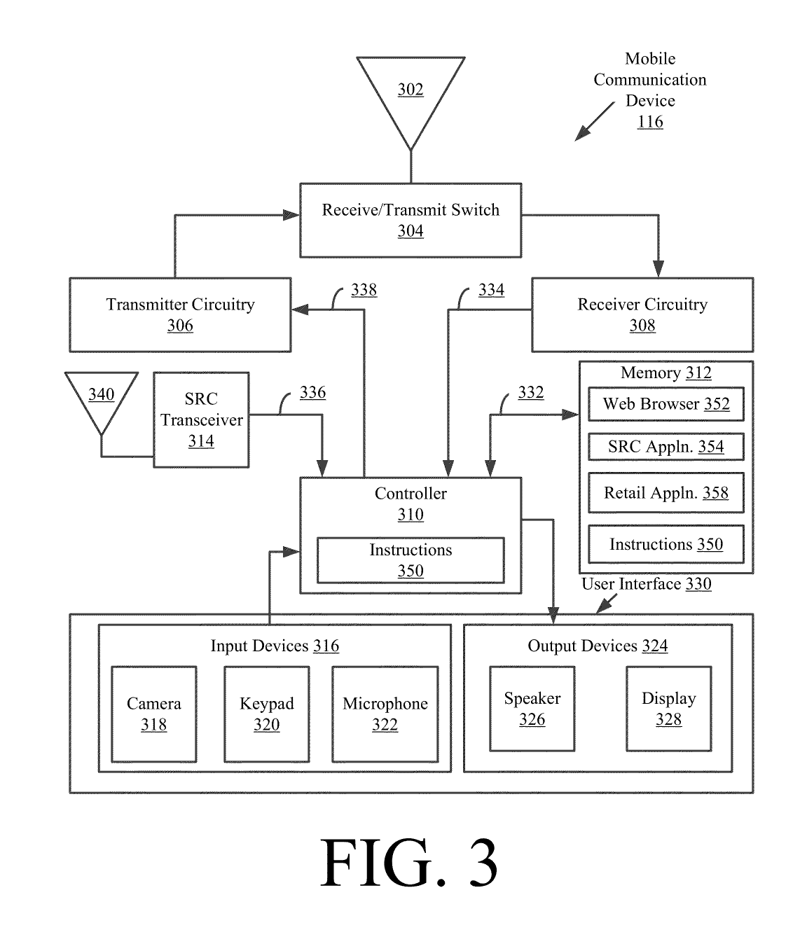

Referring now to FIG. 3, there is provided a block diagram of an exemplary architecture for MCD 116 that is useful for understanding the present invention. MCD 116 may include more or less components than those shown in FIG. 3. However, the components shown are sufficient to disclose an illustrative embodiment implementing the present invention. Some or all of the components of the MCD 116 can be implemented in hardware, software and/or a combination of hardware and software. The hardware includes, but is not limited to, one or more electronic circuits. The electronic circuit may comprise passive components (e.g., capacitors and resistors) and active components (e.g., processors) arranged and/or programmed to implement the methods disclosed herein.

MCD 116 can include, but is not limited to, a notebook computer, a personal digital assistant, a cellular phone or a mobile phone with smart device functionality (e.g., a Smartphone). In this regard, the MCD 116 comprises an antenna 302 for receiving and transmitting RF signals. A receive/transmit (“Rx/Tx”) switch 304 selectively couples the antenna 302 to the transmitter circuitry 306 and the receiver circuitry 308 in a manner familiar to those skilled in the art. The receiver circuitry 308 demodulates and decodes the RF signals received from an external device. The receiver circuitry 308 is coupled to a controller (or microprocessor) 310 via an electrical connection 334. The receiver circuitry 308 provides the decoded signal information to the controller 310. The controller 310 uses the decoded RF signal information in accordance with the function(s) of the MCD 116. The controller 310 also provides information to the transmitter circuitry 306 for encoding and modulating information into RF signals. Accordingly, the controller 210 is coupled to the transmitter circuitry 306 via an electrical connection 338. The transmitter circuitry 306 communicates the RF signals to the antenna 302 for transmission to an external device via the Rx/Tx switch 304.

MCD 116 also comprises an antenna 340 coupled to an SRC transceiver 314 for receiving SRC signals. SRC transceivers are well known in the art, and therefore will not be described in detail herein. However, it should be understood that the SRC transceiver 314 processes the SRC signals to extract information therefrom. The SRC transceiver 314 may process the SRC signals in a manner defined by the SRC application 354 installed on the MCD 116. The SRC application 354 can include, but is not limited to, a Commercial Off the Shelf (“COTS”) application. The SRC transceiver 314 is coupled to the controller 310 via an electrical connection 336. The controller uses the extracted information in accordance with the function(s) of the MCD 116. For example, the extracted information can be forwarded by the MCD 116 to an SIS (e.g., SIS 140 of FIG. 1) where it can be used for various purposes. Such purposes can include, but are not limited to: (1) increasing the security of the RSF 160, (2) providing promotional materials to the person, (3) tracking peoples paths of travel through the retail store, (4) generating a map indicating where one or more persons or security tags are located within the RSF 160, and/or (6) improving the shopping and/or check-out experience of a customer.

The controller 310 may store received and extracted information in memory 312 of the MCD 116. Accordingly, the memory 312 is connected to and accessible by the controller 310 through electrical connection 332. The memory 312 may be a volatile memory and/or a non-volatile memory. For example, memory 312 can include, but is not limited to, a RAM, a DRAM, a ROM and a flash memory. The memory 312 may also comprise unsecure memory and/or secure memory. The memory 312 can be used to store various other types of data 360 therein, such as authentication information, cryptographic information, location information, and various article-related information.

As shown in FIG. 3, one or more sets of instructions 350 are stored in memory 312. The instructions may include customizable instructions and non-customizable instructions. The instructions 350 can also reside, completely or at least partially, within the controller 310 during execution thereof by MCD 116. In this regard, the memory 312 and the controller 310 can constitute machine-readable media. The term “machine-readable media”, as used herein, refers to a single medium or multiple media that stores one or more sets of instructions 350. The term “machine-readable media”, as used here, also refers to any medium that is capable of storing, encoding or carrying the set of instructions 350 for execution by the MCD 116 and that causes the MCD 116 to perform one or more of the methodologies of the present disclosure.

The controller 310 is also connected to a user interface 330. The user interface 330 comprises input devices 316, output devices 324 and software routines (not shown in FIG. 3) configured to allow a user to interact with and control software applications (e.g., software applications 352-258 and other software applications) installed on MCD 116. Such input and output devices may include, but are not limited to, a display 328, a speaker 326, a keypad 320, a directional pad (not shown in FIG. 3), a directional knob (not shown in FIG. 3), a microphone 322, and a camera 318. The display 328 may be designed to accept touch screen inputs. As such, user interface 330 can facilitate a user software interaction for launching applications (e.g., software applications 352-258 and other software applications) installed on MCD 116. The user interface 330 can facilitate a user-software interactive session for: initiating communications with an external device; writing data to and reading data from memory 312; initiating a retail application process for providing a user with improved customer service and/or the retail store with increased security. The retail application process will be described below in detail.

The display 328, keypad 320, directional pad (not shown in FIG. 3) and directional knob (not shown in FIG. 3) can collectively provide a user with a means to initiate one or more software applications or functions of the MCD 116. The application software 352-358 can facilitate the data exchange between (a) a user and the MCD 116, (b) the MCD 116 and a POS station, (c) the MCD 116 and a beacon (e.g., beacon 130 of FIG. 1), and/or (d) the MCD 116 and an SIS (e.g., SIS 140 of FIG. 1). In this regard, the application software 352-358 performs one or more of the following: verify the identity of a user of the MCD 116 via an authentication process; present information to the user indicating that his/her identity has or has not been verified; and present a Graphical User Interface (“GUI”) to the user for enabling the user to initiate a customer service process for providing the user with improved customer service when the user is in a retail store facility (e.g., RSF 160 of FIG. 1).

The application software 352-358 also performs one or more of the following: receive information from a remotely located database (e.g., promotional materials); and/or display the received information on a display screen of the MCD 116. The application software 352-358 further performs one or more of the following: receive a unique identifier from a beacon; communicate the beacon's unique identifier and its unique identifier to a remotely located SIS; receive information from the SIS; and/or display the received information on a display screen of the MCD 116.

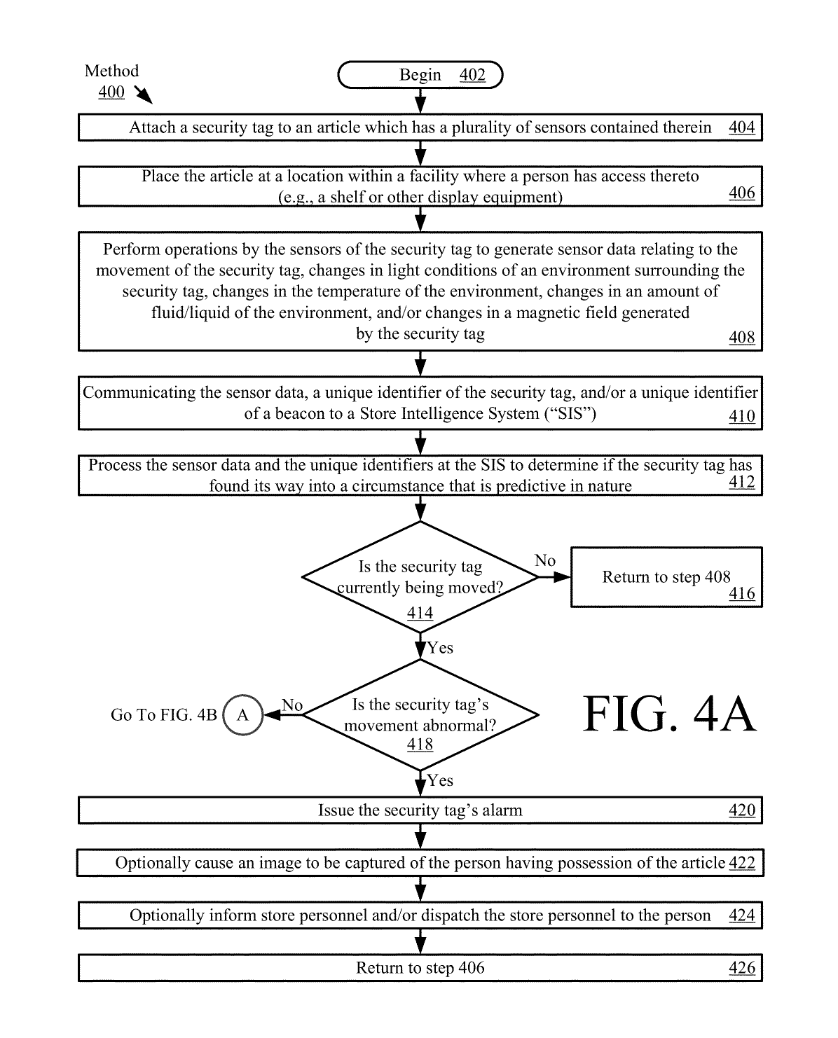

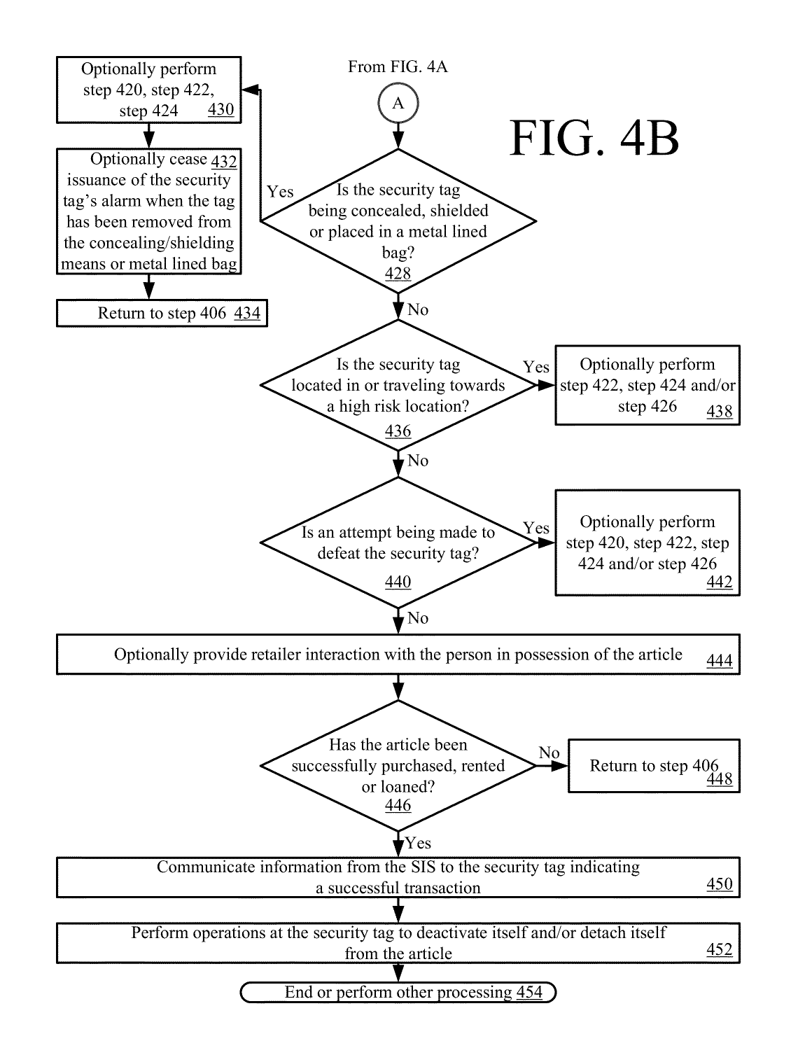

Referring now to FIGS. 4A-4B, there is provided a flow diagram of an exemplary method 400 for providing store intelligence. Method 400 may be implemented in system 100. Method 400 begins with step 402 and continues with step 404 where a security tag (e.g., security tag 122 of FIG. 1) is attached to an article (e.g., article 118 of FIG. 1). The security tag has a plurality of sensors (e.g., sensors 126 of FIG. 1) disposed therein. The sensors can include, but are not limited to, proximity sensors, temperature sensors, accelerometers, liquid sensors, light sensors, magnetic field sensors, and/or location sensors. Next in step 406, the article is placed at a location within a facility (e.g., RSF 160 of FIG. 1) where a person has access thereto (e.g., on a shelf or other display equipment).

At some time later, the sensors of the security tag perform operations in step 408 to generate sensor data. The sensor data relates to the movement of the security tag, changes in light conditions of an environment surrounding the security tag, changes in the temperature of the surrounding environment, changes in an amount of fluid/liquid contain in the surrounding environment, and/or changes in a magnetic field generated by the security tag. The sensor data is then communicated from the security tag to an SIS (e.g., SIS 140 of FIG. 1), as shown by step 410. Additionally, a unique identifier of the security tag and/or a unique identifier of a beacon (e.g., beacon 130 of FIG. 1) are also communicated to the SIS. The beacon's unique identifier is sent to specify the current location of the security tag. The present invention is not limited to this technique of tracking the location of security tags. In other scenarios, other location determining techniques (e.g., triangulation) can additionally or alternatively be employed. The sensor data and/or unique identifiers can be sent to the SIS via a proximity system (e.g., proximity system 104, 106, 108, 110 or 112 of FIG. 1) or an MCD (e.g., MCD 116 of FIG. 1). If an MCD is used, then the unique identifier of the MCD may also be communicated to the SIS.

At the SIS, the sensor data and/or unique identifiers are processed in step 412 to determine if the security tag has found its way into a circumstance that is predictive in nature. Next a decision step 414 is performed to determine if the security tag is being moved. If the security tag is not being moved [414:NO], then method 400 returns to step 408, as shown by step 416. In contrast, if the security tag is being moved [414:YES], then decision step 418 is performed to determine whether or not the security tag's movement is normal or abnormal. The decision of step 418 may be based on a current orientation of a security tag, a velocity and direction of a security tag's movement (e.g., a relatively fast downward movement of the security tag may indicate a defeat attempt such as slamming the security tag on a hard surface), a pattern of the security tag's movement over a given period of time (e.g., rapid changes in the altitude of the article may indicate that the article is being held by a person running or walking relatively fast), and/or relative altitudes of different portions of the security tag (e.g., an altitude difference of the two ends of a security tag relative to a center portion of the security tag may indicate that a defeat attempt has occurred such as bending the security tag to deform the same). Pre-stored threshold values and/or sensor data patterns (e.g., accelerometer data patterns) can be employed in comparison operations to distinguish between normal movements and abnormal movements.

If the security tag's movement is abnormal [418:YES], then step 420 is performed where the security tag's alarm is issued. Optional steps 422 and 424 may also be performed to (1) cause an image to be captured of the person having possession of the article, (2) inform store personnel of the abnormal movement, and/or (3) dispatch the store personnel to the area of the facility at which the person resides. Thereafter, method 400 returns to step 406, as shown by step 426.

In contrast, if the security tag's movement is normal [418:NO], then method 400 continues with decision step 428 of FIG. 4B. In decision step 428, a determination is made as to whether or not the security tag is being concealed, shielded or placed in a metal lined bag. This determination can be made based on (1) sensor data specifying changes in light conditions and/or temperature conditions of an environment surrounding the security tag, and/or (2) sensor data indicating a detuning of the security tag.

If the security tag is being concealed/shielded/placed in a metal bag [428:YES], then steps 430-434 are performed. Step 420 involves optionally performing step 420, 422 and/or 424. In the case that the security tag's alarm is issued, optional step 432 is performed in which the alarm's issuance is ceased when the security tag has been removed from the concealing/shielding means or metal lined bag. Thereafter, method 400 returns to step 406, as shown by step 434.

If the security tag is not being concealed/shielded/placed in a metal bag [428:NO], then decision step 436 is performed. Decision step 436 involves determining whether or not the security tag is located in or traveling towards a high risk location (e.g., an exit, a bathroom, or a dressing room). If the security tag is located in or traveling towards a high risk location [436:YES], then step 422, 424 and/or 426 are optionally performed as shown by step 438.

If the security tag is not located in or traveling towards a high risk location [436:NO], then decision step 440 is performed to determine if an attempt is being made to defeat the security tag. For example, the security tag could be placed in liquid (e.g., water) or exposed to high temperatures to defeat the same. Accordingly, the determination of step 440 can be made based on sensor data indicating a change in an amount of liquid of a surrounding environment and/or an increase in temperature of the surrounding environment.

If an attempt is being made to defeat the security tag [440:YES], then step 420, 422, 424 and/or 426 is(are) optionally performed, as shown by step 422. In contrast if an attempt is not being made to defeat the security tag [440:NO], then method 400 continues with optional step 444. Step 444 involves optionally providing retailer interaction with the person in possession of the article. The retailer interaction can include, but is not limited to, the provision of product-related information to the person, the provision of promotional materials to the person, and/or the dispatching of store personnel to assist the person with his(her) shopping experience.

The article may or may not be purchased, rented or loaned by the person. If the article has not been successfully purchased, rented or loaned [446:NO], then step 448 is performed where method 400 returns to step 406. If the article has been successfully purchased, rented or loaned [446:YES], then certain information is communicated from the SIS to the security tag indicating a successful transaction. Thereafter, the security tag performs operation to deactivate itself and/or detach itself from the article, as shown by step 452. Next, step 454 is performed where method 400 ends or other processing is performed.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for providing facility intelligence, comprising:
generating sensor data relating to movement of a security tag by at least one sensor of a plurality of sensors disposed in the security tag;
analyzing, by an electronic device remotely located from the security tag, the sensor data to determine if the security tag is currently being moved in an abnormal manner; and
selectively performing, by the electronic device, first operations facilitating facility security if a determination is made that the security tag is currently being moved in an abnormal manner.

2. The method according to claim 1, wherein the sensor data further relates to changes in light conditions of a surrounding environment, changes in a temperature of the surrounding environment, changes in an amount of fluid in a surrounding environment, or changes in a magnetic field strength generated by the security tag.

3. The method according to claim 1, further comprising selectively performing, by the electronic device, second operations facilitating customer service if a determination is made that the security tag is not being moved in an abnormal manner.

4. The method according to claim 1, further comprising providing pre-stored article-related information from the security tag to a mobile communication device if a determination is made that the security tag is not being moved in an abnormal manner or in response to reception of a query.

5. The method according to claim 1, wherein the first operations facilitating facility security comprise issuing an alarm of the security tag, causing an image to be captured of a person in possession of the security tag, notifying store personnel of the security tag's abnormal movement, or dispatching the store personnel to a location within a facility at which the security tag resides.

6. The method according to claim 1, further comprising:
analyzing, by the electronic device, the sensor data to determine if the security tag is being concealed, shielded or placed in a metal lined bag; and
selectively performing, by the electronic device, third operations facilitating facility security if a determination is made that the security tag is being concealed, shielded or placed in a metal lined bag.

7. The method according to claim 6, wherein the third operations comprise issuing an alarm of the security tag or notifying store personnel of the security tag's concealment, shielding or detuning.

8. The method according to claim 1, further comprising:
analyzing, by the electronic device, the sensor data to determine if the security tag is located in or traveling towards a high risk location of a facility; and
selectively performing, by the electronic device, fourth operations facilitating facility security if a determination is made that the security tag is located in or traveling towards a high risk location of a facility.

9. The method according to claim 1, further comprising:
analyzing, by the electronic device, the sensor data to determine if an attempt is being made to defeat the security tag; and
selectively performing, by the electronic device, fifth operations facilitating facility security if a determination is made that an attempt is being made to defeat the security tag.

10. The method according to claim 1, further comprising performing operation by the security tag to deactivate or detach itself from an article when a successful transaction regarding the article occurs.

11. A system, comprising:
a security tag having a plurality of sensors disposed therein which generate sensor data relating to movement of the security tag; and
an electronic circuit remotely located from the security tag which
analyzes the sensor data to determine if the security tag is currently being moved in an abnormal manner, and
selectively performs first operations facilitating facility security if a determination is made that the security tag is currently being moved in an abnormal manner.

12. The system according to claim 11, wherein the sensor data further relates to changes in light conditions of a surrounding environment, changes in a temperature of the surrounding environment, changes in an amount of fluid in a surrounding environment, or changes in a magnetic field strength generated by the security tag.

13. The system according to claim 11, wherein the electronic circuit further selectively performs second operations facilitating customer service if a determination is made that the security tag is not being moved in an abnormal manner.

14. The system according to claim 11, wherein the security tag provides pre-stored article-related information to a mobile communication device if a determination is made that the security tag is not being moved in an abnormal manner or in response to reception of a query.

15. The system according to claim 11, wherein the first operations facilitating facility security comprise issuing an alarm of the security tag, causing an image to be captured of a person in possession of the security tag, notifying store personnel of the security tag's abnormal movement, or dispatching the store personnel to a location within a facility at which the security tag resides.

16. The system according to claim 11, wherein the electronic device further
analyzes the sensor data to determine if the security tag is being concealed, shielded or placed in a metal lined bag, and
selectively performs third operations facilitating facility security if a determination is made that the security tag is being concealed, shielded or placed in a metal lined bag.

17. The system according to claim 16, wherein the third operations comprise issuing an alarm of the security tag or notifying store personnel of the security tag's concealment, shielding or detuning.

18. The system according to claim 11, wherein the electronic device further
analyzes the sensor data to determine if the security tag is located in or traveling towards a high risk location of a facility, and
selectively performs fourth operations facilitating facility security if a determination is made that the security tag is located in or traveling towards a high risk location of a facility.

19. The system according to claim 11, wherein the electronic device further
analyzes the sensor data to determine if an attempt is being made to defeat the security tag, and
selectively performs fifth operations facilitating facility security if a determination is made that an attempt is being made to defeat the security tag.

20. The system according to claim 11, wherein the security tag performs operations to deactivate or detach itself from an article when a successful transaction regarding the article occurs.
